(19) United States
(12) Patent Application Publication
(10) Pub. No.: US 2025/0174383 A1
(43) Pub. Date: May 29, 2025

(54) MAGNET WIRE WITH A COMPOSITE COATING

(71) Applicant: Magnekon, S.A. de C.V., Nuevo León (MX)

(72) Inventors: Juan Carlos MORALES HUERTA, Nuevo León (MX); Edgar Alberto DUARTE PEÑA, Nuevo León (MX); Francisco DÍAZ CAMACHO, Nuevo León (MX)

(21) Appl. No.: 18/523,383

(22) Filed: Nov. 29, 2023

(51) Int. Cl. H01F 5/06; C09D 5/00; C09D 7/20; C09D 7/40; C09D 7/61; C09D 7/65; C09K 5/14; H01F 41/12

(52) U.S. Cl. CPC H01F 5/06; C09D 5/002; C09D 7/20; C09D 7/61; C09D 7/65; C09D 7/67; C09K 5/14; H01F 41/12

(57) ABSTRACT

A magnet wire is configured for transmitting and distributing electrical energy. A wire includes a conductor and a coaxially arranged coating surrounding the conductor. The coating is composed of a polymeric resin and a thermally conductive inorganic filler. The coating surrounding the conductor may be configured in a matrix and/or array, with alternating layers. Alternatively, the coating is formed as a single layer. Placing the coating on the conductor substantially enhances the mechanical, chemical, dielectric, and thermal conductivity properties of the cable, primarily due to the interaction between the quantity, proportion, and distribution of the components comprising the coating.

### FIELD OF THE INVENTION

The present invention relates, in general, to a magnet wire that comprises or has applied to it a coating composed of a polymeric material, together with an inorganic material formed by nanoparticles. In particular, the present invention is directed to a magnet wire and a coating, where the combination and configuration of the coating provide the magnet wire with improved mechanical, dielectric, chemical, and thermal conductivity properties, offering a significant and advantageous enhancement in heat conduction along the wire to prevent points of heat overexposure.

### BACKGROUND OF THE INVENTION

Currently, there are numerous activities that involve the use of magnet wire; mainly within the field of electric power flow from a generating source to a component powered by said electric power, thus achieving a desired action. However, it is known that a relevant technical issue with such wires is the degradation of these wires and the consequent reduction of their service life, mainly resulting from operating conditions.

A significant number of electric power transmission activities that use magnet wire are affected by the presence of high temperatures and/or thermal shocks that significantly degrade the wire material; similarly, the use of high voltages and, consequently, high currents, high frequencies, and/or pulsating voltages/currents can even accelerate wire failure. Additionally, it is known that in many operations, these wires are exposed to corrosive and/or highly corrosive environments, for example, when they come into contact with different substances, which are also relevant factors for degrading the integrity of the magnet wire.

The above represents a significant technical issue, both from an economic point of view, meaning the need to replace damaged wire or wire that has suffered sufficient degradation to no longer offer proper or efficient electrical power conduction, and, on the other hand, a problem that can translate into damage to more significant elements resulting from a reduction in the properties of the magnet wire. For example, the significant degradation of thermal conductivity capacity can damage a secondary and/or dependent element of said magnet wire and/or result in a significant degradation of its dielectric properties, affecting or potentially affecting electrical elements that should not be exposed to electrical flow, among others.

Taking into account the above, various technologies have been developed and incorporated into electric power transmission cables. For example, U.S. Pat. No. 7,196,270 B2 published on Jun. 15, 2006, U.S. Pat. No. 10,811,163 B2 published on Jan. 31, 2013, and Russian Patent RU2547011C2 published on Mar. 10, 2014, disclose cables formed by an electric conductor, which is surrounded by one or a plurality of extruded layers or coatings of a thermoplastic polymeric material. Both cables with coatings from the aforementioned patents U.S. Pat. No. 7,196,270 B2 and U.S. Pat. No. 10,811,163 B2 exhibit a plurality of coaxial layers surrounding the conductive material, which act as insulators under specific conditions.

It can be observed that the plurality of layers and/or coatings from these previously cited documents provide means with a specific thermal conductivity, which allows the dissipation of heat generated therein, as well as a specific dielectric coefficient, preventing exposure of electrical flow to external components of the cable. Moreover, technologies are known that have incorporated, in addition to polymeric components, the inclusion of nanoparticles to modify these thermal and dielectric conductivity properties. This is the case with patent applications U.S. 2007/0134411 A1 published on Jun. 14, 2007, and U.S. 2021/0395523 A1 published on Dec. 23, 2021, which describe methods and compositions that use carbon-based nanocapsules and nanotubes, demonstrating an improvement in thermal conductivity and dielectric strength when mixed with polymeric materials, in comparison to the use of polymers alone, as described in U.S. Pat. No. 7,196,270 B2 and U.S. Pat. No. 10,811,163 B2.

Similarly, the PCT patent publication WO 2018/073123 A1 published on Apr. 26, 2018, teaches the use of polymer-based compounds that offer specific thermal conductivity and dielectric resistance properties and can be used as fillers, analogous to the coatings of the aforementioned prior art documents. U.S. Patent US20100081744 published on Apr. 9, 2008, as well as U.S. Pat. No. 6,265,466B1 published on Jul. 24, 2001, refer to polymer resin coatings formed by nanotubes, which similarly, like WO 2018/073123 A1, when applied to an electric power conductor, provide specific thermal and mechanical conductivity properties.

Additionally, it is known in the prior art, particularly in the field to which the present invention belongs, U.S. Patent Application No. 20230044358A1, published on Feb. 9, 2023, which describes a magnet wire with improved partial discharge performance. This magnet wire from US'358 has a conductor, a first layer of polymer enamel insulation formed around the conductor, and a second layer of polymer enamel formed around the first layer. The second layer may be a semiconductive layer that includes a base polymer material and filler particles dispersed within the base polymer material. Furthermore, at least sixty percent by weight of the filler particles may be positioned in the outer half of the thickness of the second layer. However, it is clear that the technical issue addressed by this U.S. application is to provide a plurality of coatings or films aimed at increasing the coating's lifespan.

In view of the above, it is evident that there is a need to provide a magnet wire with a coating that, through a more efficient combination of its components, can not only offer a longer lifespan but also improve various properties, particularly heat conductivity properties. Similarly, it is clear that there is a need to provide a wire that, based on its conformation, arrangement, and/or distribution, substantially offers improved properties compared to those disclosed in the prior art, particularly enhancing aspects such as thermal conductivity, dielectric, mechanical, and chemical resistance, using a composition based on polymer resins and inorganic fillers complemented with nanostructure-like elements, offering a final product with a substantially longer (average) service life compared to currently commercial products and benefiting from the knowledge currently disclosed and known in the prior art, primarily providing a magnet wire with improved heat conduction properties.

### SUMMARY OF THE INVENTION

Therefore, the present invention focuses on providing a magnet wire coated or to which a composite coating is applied. More specifically, the present invention aims to provide a method for generating a composite coating and the methodology for its application to the aforementioned magnet wire. This results in significant improvements in mechanical, dielectric, chemical, and thermal conductivity properties of the magnet wire once it is applied.

These improvements translate into a substantial increase in the wire's service life under challenging operational conditions, such as high voltages, voltage spikes, overloads, high frequencies, pulsating voltages, elevated ambient temperatures, and electric power flows through the wire, as well as abrupt temperature changes.

In particular, the present invention is directed towards providing a magnet wire coated with a combination of polymeric resin and inorganic filler, where the mentioned coating surrounds the cable's central conductor. Based on the properties, arrangement, combination, and other characteristics of the coating applied to the magnet wire, the wire offers improved thermal conductivity.

The present invention, in its various embodiments, provides methods for generating a coating, as well as the ideal proportions and distributions of materials. It will be evident to one skilled in the art that these have not been previously disclosed within the prior art.

A person skilled in the field to which the invention pertains will understand that the materials involved are known and widely used. However, it should be clear to such a person that, upon a holistic review of this application, the proportion, arrangement, distribution, and, above all, the resulting interaction between them, yield a completely novel and even unexpected result. This translates into a substantial improvement in the performance of the magnet wires described in this patent application compared to those currently existing within the prior art.

The validity of the aforementioned can be robustly supported by detailed experimental tests, which are presented later in this application.

### BRIEF DESCRIPTION OF THE DRAWINGS

Having described the invention in the above general terms, reference will now be made to the accompanying drawings showing representative embodiments of the present invention, where:

FIG. 1 is a cross-sectional view of a diagram of a magnet wire (MW) with its corresponding conductor (10) and its coating (polymeric base layer (20)) and a thermally conductive overcoat (30);

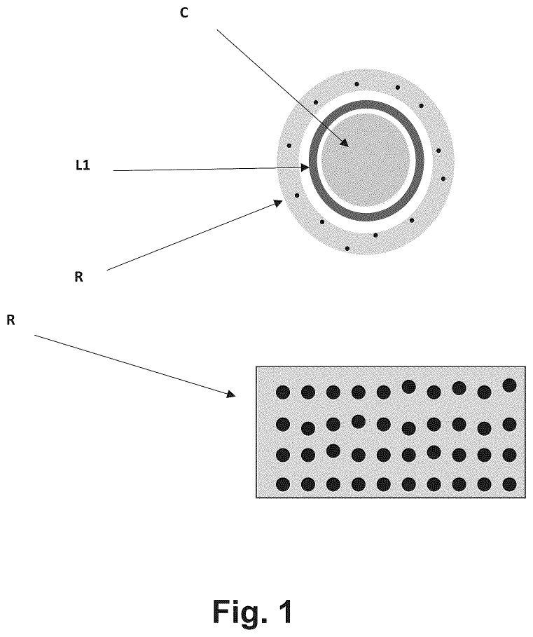

FIG. 2 illustrates a graph modeling the thermal conductivity behavior (W/mK) concerning the weight percentage of epoxy-type polymeric resin, according to a non-limiting example of the present invention;

FIG. 3 shows a graph modeling the thermal conductivity behavior (W/mK) concerning the weight percentage of unsaturated polyester-type polymeric resin, according to a non-limiting example of the present invention;

FIG. 4 displays a simplified flowchart of the method according to the present invention, with the referenced method aimed at obtaining an improved magnet wire, according to one embodiment of the present invention; and

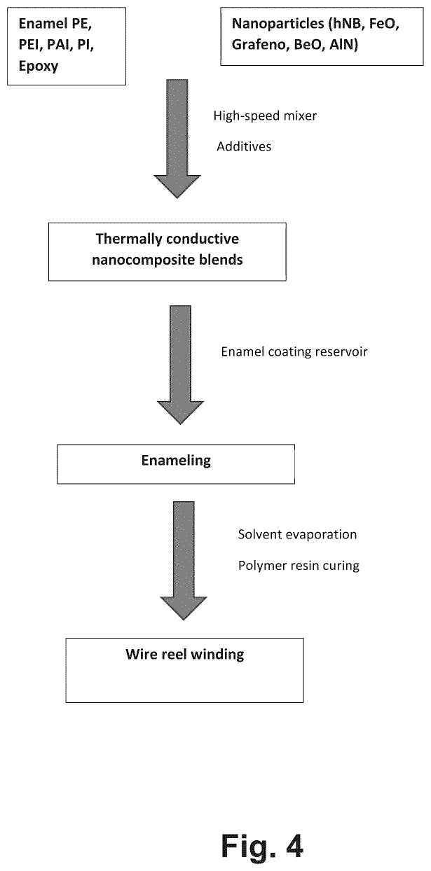

FIG. 5(a-g) presents a schematic diagram of a sequence exemplifying the method, in accordance with the present invention. It specifically illustrates the experimental sequence executed to generate the coating designed for subsequent application to a conductor, in order to produce a magnet wire as per the present invention.

### DETAILED DESCRIPTION OF THE INVENTION

Certain aspects of the present invention will now be described in more detail, with reference to the attached drawings illustrating some embodiments and advantages of the present invention.

When referring to “improvement in its properties,” it should be understood as a substantial improvement compared to wires coated solely with conventional polymeric materials and nanomaterials comprising the inorganic filler. This improvement is based on the amount of material used, its distribution, arrangement, configuration, and composition, as described in detail in this patent application.

It should also be understood that the technical problem addressed by the present invention is the overheating present in a magnet wire. Given its nature, i.e., the conduction of electrical energy (current) through it, as well as the environmental conditions in its application environment, compromise the integrity of the wire. This is because the lack of proper heat dissipation could result in a thermal concentration that would seriously affect the magnet wire's integrity, both in terms of its service life and its average performance.

The present invention provides an innovative and novel solution to the previously mentioned technical problem, which, as mentioned earlier, is based on the application of a composite coating on the magnet wire, as well as the overall combination and interaction of each component of the composite coating, its arrangement, configuration, and the methodology of its generation and application. This imparts improved properties to the magnet wire, including significantly enhanced thermal conductivity.

In the context of the present invention, “polymeric resin” should be understood as polyester, polyetherimide, polyamideimide, polyurethane, or any other polymer that can be used as the composite matrix.

By “coating,” it should be understood as the polymeric layer that serves as an electrical insulator, usually of polymeric origin, between conductors. However, a person skilled in the art will understand that suitable materials may essentially be polymers, but other suitable materials can be used without departing from the present invention. Suitable materials can be any of those disclosed throughout this application, as well as materials with similar properties and behaviors.

By “conductor,” it should be understood as any element that conducts electric current, primarily made of metallic materials, mainly copper and/or aluminum.

For “thermally conductive inorganic filler,” it should be understood as any inorganic material, mainly of nanometric size, that is metallic or ceramic and has a thermal conductivity constant equal to or greater than 30 W/mK.

An “appropriate metallic cable” should be understood as any commercially available and currently known material that, based on its conductive properties, can efficiently transmit electric energy from a source to a connected element. Generally, the conductor (C) can be of any material selected from the group comprising metals such as copper or aluminum, combinations thereof, and the like.

A “surface treatment” should be understood as those chemical modification procedures of fillers such as silanization, modification of particles with terminal groups such as OH, Epoxy, among others.

In the context of the present invention, a “compatibilization method” should be understood as the modification of the surface tension of the enamel through the use of surfactants or rheology modifiers.

For “thermally conductive nanostructures,” it should be understood as any ceramic or metallic nanoscale particle (less than 100 nm) that can be used for heat dissipation, preventing conductor overheating. In this sense, such nanostructures are preferably fullerene-like structures, but other structures such as plates, flakes, hexagonals can be applied without departing from the teachings and scope of the present invention. In a preferred embodiment, as will be described in more detail later in this application, the use of different structures for fullerene-like structures provides the composite coating according to the present invention with a significant and advantageous improvement in the thermal conductivity property of the magnet wire. Furthermore, the inventors have found that, particularly, the use of the aforementioned hexagonal, plate, and/or flake structures corresponding to fullerene-like structures, in combination with the other elements comprising the composite coating of the present invention, offers a substantial improvement in the thermal conductivity of the magnet wire.

It should be understood that the technical problem addressed by the present invention is the overheating present in a magnet wire, which, given its nature, i.e., the conduction of electrical energy (current) through it, as well as the environmental conditions in its application environment, compromise the integrity of the cable. This is because the lack of proper heat dissipation could result in a thermal concentration that would seriously affect the magnet wire's integrity, both in terms of its service life and its average performance.

The present invention provides an innovative and novel solution to the previously mentioned technical problem, which, as mentioned earlier, is based on the application of a composite coating on the magnet wire, as well as the overall combination and interaction of each component of the composite coating, its arrangement, configuration, and the methodology of its generation and application. This imparts various improved properties to the magnet wire, including highly enhanced thermal conductivity.

Furthermore, in the context of the present invention, “solvents” should be interpreted as any liquid substance capable of dissolving a polymer.

In the context of the present invention, an “antislip agent” should be understood as any additive that migrates to the surface and reduces the coefficient of friction, allowing for better lubrication between a machine and the material in question, resulting in a better finish on the conductor.

In the context of the present invention, a “colorant” should be interpreted as any organic and/or inorganic pigment that modifies the coating's color.

For a person skilled in the art, it will be evident that various embodiments of the invention can be expressed in different ways and should not be interpreted as limited to the embodiments described here. Instead, these exemplary embodiments are provided to make this invention clear and complete, fully conveying the scope of the invention to those skilled in the art. For example, unless otherwise indicated, something described as “first,” “second,” or similar should not be interpreted as a particular order. As used in the description and in the attached claims, singular forms such as “a,” “an,” “the,” include plural referents unless the context clearly indicates otherwise.

The different aspects of the present invention relate to a magnet wire configured to transmit and distribute electric energy. In particular, the present invention refers to a magnet wire formed by a conductor (C) and a coating (R) coaxially disposed with respect to the conductor (C), surrounding it. This coating (R) consists of polymeric resin and thermally conductive inorganic filler.

In a preferred embodiment of the present invention, the coating (R) surrounding the conductor (C) can be structured in the form of a matrix and/or arrangement, with alternating layers, or in an additional embodiment, the coating (R) is formed as a single layer.

In any of the embodiments of the present invention, when the coating (R) is placed over the conductor (C), it substantially enhances the mechanical, chemical, dielectric, and thermal conductivity properties of the wire. This enhancement results from the interaction between the quantity, proportion, and distribution of the components that make up the coating (R).

The magnet wire of the present invention comprises a conductor (C), also referred to as an electrical conductor wire, or simply conductor wire, which is typically a suitable metallic wire designed to transmit and conduct electrical energy.

Furthermore, the conductor (C) can have any suitable diameter, ranging from 0.5 mm to “n” millimeters in diameter. More specifically, the conductor (C) can have a diameter ranging from 0.5 mm to 30 mm, or even more specifically, a diameter ranging from 1 mm to 20 mm.

Additionally, the cable of the present invention includes a coating (R) which, in any embodiment, is arranged to surround the aforementioned conductor (C).

The coating (R), in any embodiment of the present invention, is composed of at least a polymeric resin and a thermally conductive inorganic filler.

In one embodiment, the coating (R) may consist of 65% to 99.95% by weight of a polymeric resin and 0.05 to 35% by weight of a thermally conductive inorganic filler.

More particularly, the thermally conductive inorganic filler can be comprised of nanostructures, which, in turn, may be fullerenes selected from the group including silicon oxide, magnesium oxide, iron oxide (Ill), antimony oxide (Ill), boron nitride (hBN), graphene, combinations thereof, and the like.

The aforementioned nanostructures can be fullerenes, but other structures such as plates, flakes, hexagonal shapes can be applied without departing from the teachings and scope of the present invention.

In a preferred embodiment, the nanostructures according to the present invention can be hexagonal, plate-like, and/or flake-like structures. These, in combination with the other elements constituting the composite coating of the present invention, provide a substantial improvement in the thermal conductivity of the magnet wire.

In an additional embodiment, these nanostructures may include beryllium oxide (BeO), silicon dioxide (SiO2), aluminum nitride (AlN), titanium dioxide (TiO2).

In any of the aforementioned embodiments, the mixture of the polymeric resin with the thermally conductive inorganic filler can be dissolved, preferably, in at least one to “n” quantity of solvents.

Appropriate solvents for receiving this mixture can be selected from the group including cresylic acid, N-methyl-2-pyrrolidone, phenol, aromatic hydrocarbons, dimethylformamide, mesitol, benzyl alcohol, paracresol, metacresol, m-cresol, toluene, xylene, tetrahydrofuran, dimethyl sulfoxide, butyl alcohol, butyl cellosolve, combinations thereof, and the like.

Additionally, in one embodiment, the coating (R) may include a slip-promoting agent. This slip-promoting agent can be selected from the group including polyvinyl fluoride, tetrafluoroethylene-perfluoro(alkyl vinyl ether) copolymer, tetrafluoroethylene hexafluoropropylene-perfluoro(alkyl vinyl ether) copolymer, ethylene-tetrafluoroethylene copolymer, polytetrafluoroethylene, polyvinylidene fluoride, ethylene-chlorotrifluoroethylene copolymer, polychlorotrifluoroethylene, carnauba, montan wax, combinations thereof, and the like.

Moreover, the aforementioned polymeric resin can be a thermoplastic and/or thermosetting resin, chosen from the group including acrylic, terephthalic acid alkyd, polyester, polyetherimide, polyamideimide, polyamide-imidaimide, polyurethane, epoxy resin, polyvinyl formal, polyamide, polyimide, polysulfone, polyvinyl butyral, silicon resin, polyhydroxyimide, phenolic resin, vinyl copolymer, polyolefin, polycarbonate, polyether, polyetherimide, polyetherimidaimide, polyisocyanate, polyamide-ester, polyimide-ester, combinations thereof, and the like.

Furthermore, the thermally conductive inorganic filler undergoes a surface treatment, which serves as a compatibilization method to integrate it into the aforementioned polymeric resin. In one embodiment, this surface treatment can be any selected from the group including [add specific surface treatments, if applicable].

As previously mentioned throughout this application, the present invention also provides a method for the generation and application of a composite coating, as previously described, on or applied to a magnet wire. Specifically, the composite coating can be any selected from the embodiments described throughout this application, including all features, arrangements, combinations, and dispositions as described herein.

The purpose of this method is to provide a detailed guide for manufacturing magnet wires improved with thermally conductive enamel, in accordance with any of the embodiments described in this application. This method includes the incorporation of nanoparticles into a polymeric enamel, resulting in improved thermal and magnetic properties of the wires, thereby delivering superior performance in electromagnetic applications.

### Materials and Equipment Used:

1. Nanoparticles: Carefully select specific nanoparticles, which can be any chosen from the group comprising hBN, BeO, or FeO, combinations thereof, and the like, depending on the desired properties of the magnet wire.

2. Polymers: Choose the appropriate polymer, which can be selected from any of the group comprising polyethylene (PE), polyetherimide (PEI), polyamide-imide (PAI), or polyimide (PI), combinations thereof, and the like, depending on the application requirements.

3. Solvent: Prepare a precise solvent mixture, comprising any selected from the group including cresols, amines, xylene, combinations thereof, and the like, to effectively dissolve the polymer.

4. Mixing Container: Use a robust and suitable container to hold the mixture of nanoparticles and enamel.

5. High-Speed Disperser: Have a disperser capable of agitating the mixture at a constant speed of approximately 1000 rpm.

6. Additives: Prepare necessary additives that will facilitate the even dispersion of nanoparticles in the enamel.

7. Enameling Machine: Have an enameling machine equipped to efficiently apply the enamel to the magnet wire.

8. Drying and Curing Oven: Possess an appropriate oven for the drying and curing process, allowing the solvent to evaporate and the polymer to solidify.

9. Copper or Aluminum Wire: Select the base wire type (copper or aluminum) according to the project's requirements.

10. Spools: Prepare spools where the finished magnet wire will be wound.

### Procedure:

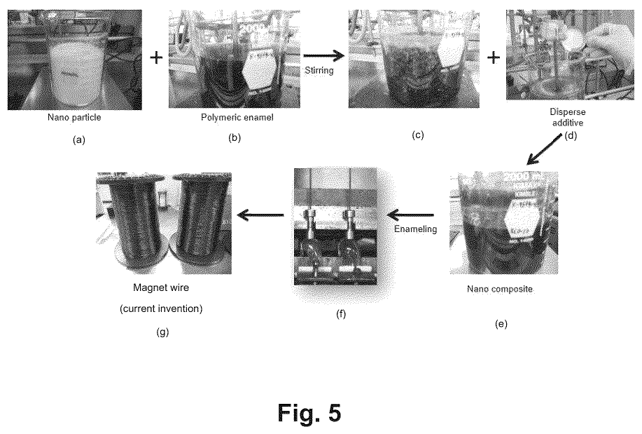

As illustrated in FIG. 5, the procedure for preparing the coating, in accordance with the present invention, includes the following steps:

1. Preparation of the Nanoparticle and Enamel Mixture: a. Accurately measure and weigh the required amount of nanoparticles and the selected polymer. In one embodiment, the required amount of nanoparticles falls within a range of 0.5% to 15%. b. Dissolve the polymer in the prepared solvent; in one embodiment, the polymer dissolution in the prepared solvent can be in a range from 18% to 45% solids, ensuring a homogeneous mixture. c. Gradually incorporate the nanoparticles into the enamel while maintaining constant agitation with the high-speed disperser. d. Continue agitation for at least 1 hour to achieve uniform dispersion and prevent nanoparticle segregation.

2. Addition of Additives: a. Without interrupting agitation, introduce necessary additives to improve nanoparticle dispersion in the enamel. In one embodiment, required additives may fall within a range of 0.1% to 2% of the total formulation. b. Maintain agitation for an additional 2 hours to ensure proper dispersion and prevent nanoparticle settling at the bottom of the container.

3. Enameling Process: a. Transfer the resulting mixture to an enameling machine designed to evenly apply the enamel to the wire.

4. Coating of the Wire: a. Pass the copper or aluminum wire at high speed through the enameling dies in the machine. b. During this process, the wire is coated with nanoparticle-loaded thermally conductive enamel.

5. Drying and Curing: a. The coated wire enters a drying and curing oven within the enameling machine, which, in one embodiment, is set at a temperature ranging from 200° C. to 500° C. b. In this oven, the solvent completely evaporates, and the polymer cures, achieving strong adhesion of the enamel to the wire.

6. Obtaining the Magnet Wire with Thermally Conductive Enamel: a. Once the solvent has completely evaporated and the curing process is complete, the magnet wire with thermally conductive enamel is ready for use.

7. Winding: a. Wind the finished magnet wire onto appropriate spools, preparing it for implementation in various electromagnetic applications.

Based on the methodology according to the present invention, upon a holistic reading of the same, the resulting effect is evident, namely, the manufacture of improved magnet wires. This improvement and significant advantage over the prior art directly result from the application and use of thermally conductive enamel comprising nanoparticles and the components referred to in any of the embodiments throughout this application.

The process, from mixture preparation to obtaining the final wire, guarantees a significant improvement in thermal and magnetic properties. This has a positive impact on electromagnetic devices in various industries and a wide range of industrial applications. This technique provides a solid foundation for creating advanced magnet wires with applications in electric motors, generators, transformers, and other electromagnetic devices.

### EXAMPLES

Below, the experimental processes and the results obtained are described to support and/or confirm the enhanced, advantageous, novel, and innovative efficiency of the present invention.

Based on the description provided in this application, a magnet wire comprising a conductor (C) with a coating from thermally conductive enamel and nanoparticle filler was used.

The magnet wire used includes a coating (R) with an arrangement/matrix according to a preferred embodiment of the present invention, considering a distribution and/or sandwich-type arrangement, as described below.

A first layer (L1) was incorporated between the conductor (C) and the outer coating (Rext). The first layer (L1) is made of polymeric resin, particularly based on polyetherimide. Subsequently, an adhesive layer (Ad1) was added, completely surrounding the outer coating (Rext). This layer, also known as a semiconductive layer, includes a thermosetting adhesive resin designed to efficiently facilitate the bonding and coupling between the first layer (L1) and the outer coating (Rext).

This semiconductive layer or adhesive layer (Ad1) was manufactured using the following methodology:
Firstly, enamel with inorganic load is prepared. The enamel can be any polymer dissolved in a solvent or a solid solvent system, comprising 18% to 45% by weight. The polymers used included Epoxy, PAI, PEI, PI, and PE solubilized in a solvent or solvent system such as cresylic acid, xylene, amines, or NMP, and a thermally conductive inorganic load such as Graphene, hBN, Silicon Oxide, Magnesium Oxide, Iron Oxide (Ill), Antimony Oxide (Ill), or similar materials, ranging from 0.5% to 15%. Additives such as dispersants, surfactants, and surface modifiers were added, ranging from 0.1% to 2% in the formulation.

In one embodiment, these nanostructures could also include beryllium oxide (BeO), silicon dioxide (SiO2), aluminum nitride (AlN), titanium dioxide (TiO2). To the enamel, thermally conductive inorganic fillers were added at a rate of 0.5 to 5 kg/h in a high-speed disperser. Surface modifiers and anti-settling agents were added to achieve proper dispersion.

Viscosities can range from 500 cP to 9000 cP, and thermal conductivities can go up to 2.5. Thermal conductivities were measured on 5 mm thick films with a diameter of 6 cm, cured at ambient conditions.

Once the enamel is obtained, the magnet wire is manufactured in an enameling machine, where, as previously described in this disclosure, the adhesive (Ad1) or semiconductive layer is composed of a mixture contained within a solvent. This mixture is a composition of polymeric resin along with nanostructures. The enameling machine is adjusted to different speeds and temperatures, involving various coating passes, to achieve an appropriate finish with the necessary mechanical properties. The first layer is a PE or PEI resin without inorganic fillers, and the thickness complies with NEMA standards, primarily 18-20 AWG.

Finally, the outer coating (Rext), also known as the thermally conductive layer, is made of polyamideimide enamel with thermally conductive nanoparticles, which is enameled, leaving the outermost layer.

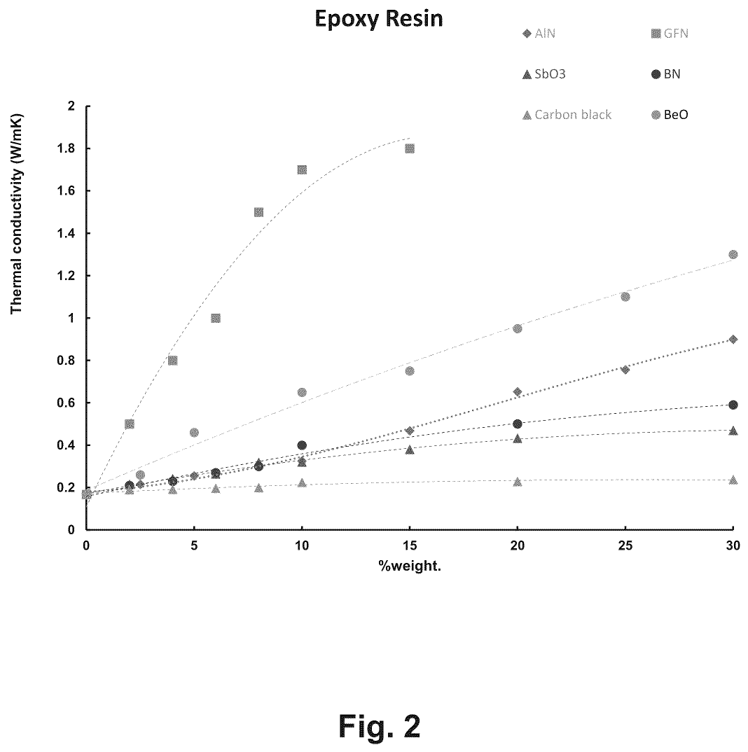

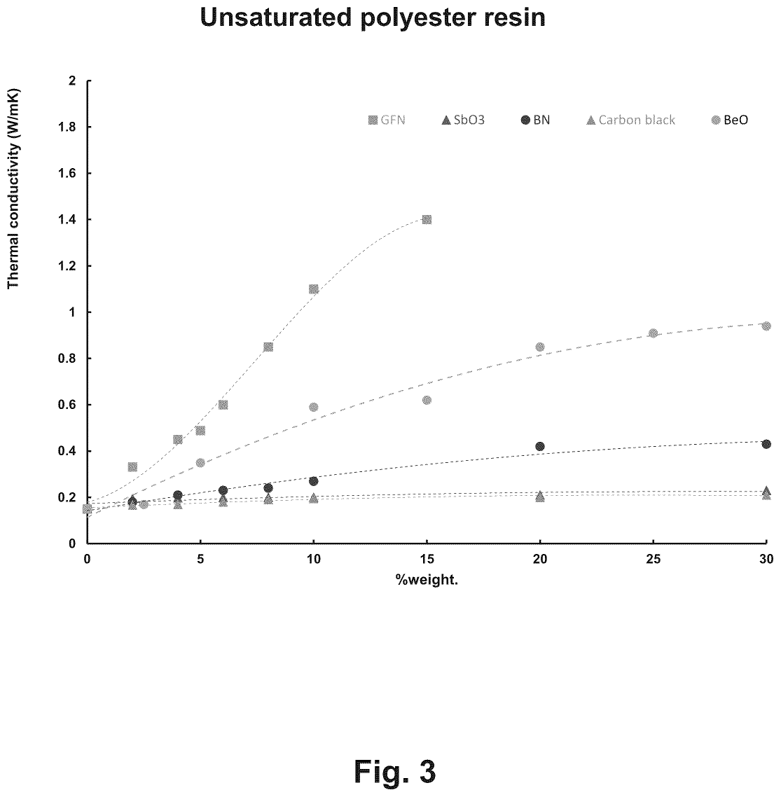

Based on the aforementioned conditions, tests were conducted to evaluate pulse resistance, motor operation under conditions of high temperature, high voltage, high frequency, voltage spikes, as well as sinusoidal voltage tests and overloads, partial discharge voltage inception (PDIV) as illustrated in Table 1 and FIGS. 2 and 3 accompanying this application, the results are shown.

Considering the results obtained, it is possible to determine the average service life, measured through the mean time to failure, as shown in Table 1 below.

| | Mean Time to Failure MTTF (s) | | | | | |
|---|---|---|---|---|---|---|
| | | CI 95% | CI 95% | Percentile | | |
| Reel Device | Estimation | Lower | Upper | 5% | 10% | 50% |
| Current | 1 366 245 | 1 130 530 | 1 651 105 | 545 669 | 700 860 | 1 349 321 |
| invention | | | | | | |
| C A | 1 799 | 1 608 | 2 012 | 780 | 1 248 | 1 820 |
| C B | 774 | 709 | 844 | 598 | 645 | 784 |
| C D | 1 523 405 | 1 036 987 | 2 237 987 | 141 866 | 506 715 | 1 406 114 |
| C E | 527 415 | 306 728 | 906 884 | 58 056 | 101 030 | 430 652 |
| C F | 279 098 | 231 134 | 337 015 | 65 580 | 145 663 | 276 189 |

It is evident that the incorporation of the coating (R) onto the conductor (C), as described throughout this application, results in a wire that, despite having conductive particles, offers substantially and advantageously improved resistance, even when compared to wires using the teachings known within the prior art.

In particular, the proposed arrangement/disposition within this application, and more specifically, the interaction resulting from the composition of polymeric resin along with the inorganic thermally conductive filler, is highly beneficial in enhancing the cable's resistance to highly degrading conditions, such as:

Conditions involving the presence and/or generation of a significant amount of heat and/or thermal shocks, where based on this arrangement/disposition, a thermal conductivity of at least 1 W/mK and up to 40 W/mK is achieved. This, in turn, ensures better dissipation of heat generated towards the exterior of the cable, preventing its degradation and/or the degradation of individual components.

Conditions with high voltages, frequencies, voltage spikes, overloads, and the like, where such phenomena typically degrade coatings due to arcing and/or dielectric breakdowns. With this arrangement/disposition, a conductivity of at least 1×10º S/cm and up to 1×10 S/cm is achieved, along with a dielectric strength of at least 7874 V/mm [200 V/mil].

Conditions where the cable's operational application involves smaller dimensions, without compromising the effectiveness of improved thermal and electrical conductivity or other resistances. Additionally, it exhibits improved adhesion between the different layers (L1-Ad1-Rext) and the conductor (C), resulting in a significant enhancement of the cable's mechanical properties. This includes increased flexibility and elongation capacity, resisting deformation and stresses generated due to bending and/or torsion, a substantial reduction in the springback effect, as well as improved resistance to wear due to friction and/or surface effects.

Conditions involving exposure to chemical environments, where this arrangement/disposition leads to a substantial improvement in solubility and overall chemical compatibility among each of the components and/or among themselves, and/or in interaction with other chemicals present in the cable's operational environment. This reduction minimizes potential damage due to such factors.

1. A magnet wire with a composite coating, the composite coating comprising a combination of:
75% to 99.95% by weight of polymeric resin; and
0.05% to 25% by weight of a thermally conductive inorganic filler;
wherein said thermally conductive filler has a surface treatment to fully integrate it into the polymer; and
wherein the thermally conductive inorganic filler can be formed by nanostructures, which in turn can be Fullerenes or other structures such as platelets, flakes, hexagonal shapes.

2. The magnet wire of claim 1, wherein the thermally conductive dielectric coating is formed by alternating layers of polymeric resin and layers consisting of a mixture of polymeric resin and thermally conductive fillers.

3. The magnet wire of claim 1, wherein the thermally conductive inorganic filler has a thermal conductivity of at least 20 W/mºK.

4. The magnet wire of claim 1, wherein the thermally conductive coating is formed by an inner layer, an outer layer of polymeric resin, and an intermediate layer of a mixture of polymeric resin and thermally conductive fillers.

5. The magnet wire of claim 1, wherein the thermally conductive coating is formed by a single layer of a mixture of polymeric resin and thermally conductive nanostructures.

6. The magnet wire of claim 1, wherein the polymeric resin is thermoplastic or thermosetting and is selected from a group consisting of acrylic, terephthalic acid alkyd, polyester, polyetherimide, polyamideimide, polyesterurethane, polyurethane, epoxy resin, polyvinyl formal, polyamide, polyimide, polyamideimide, polysulfone, polyvinyl butyral, silicone resin, polyhydantoin-incorporating polymer, phenolic resin, vinyl copolymer, polyolefin, polycarbonate, polyether, polyetherimide, polyetheramide, polyetheramidaimide, polyisocyanate, polyesterolamideimide, polyamide-ester, polyimide-ester, and combinations thereof.

7. The magnet wire of claim 1, wherein the polymeric resin has a dielectric strength of at least 7874 V/mm (200 V/mil).

8. The magnet wire of claim 1, wherein the fullerene-type nanostructures are selected from a group consisting of BeO, hBN, SiO2, Aluminum Nitride (AlN), Titanium Dioxide (TiO2), Graphene, Fe2O3, with a surface treatment.

9. The magnet wire of claim 1, wherein the thermally conductive filler has in-plane thermal conductivity of at least 1 W/mºK.

10. The magnet wire of claim 1, wherein the polymeric resin and fullerene-type nanostructures are dissolved in one or more solvents selected from a group consisting of cresylic acid, N-methyl pyrrolidone, phenol, aromatic hydrocarbons, dimethylformamide, mesitol, benzyl alcohol, paracresol, meta-cresol, toluene, xylene, tetrahydrofuran, dimethyl sulfoxide, butyl alcohol, butyl cellosolve, and combinations thereof.

11. The magnet wire of claim 1, further comprising a first layer between the electrical conductor and the coating.

12. The magnet wire of claim 11, wherein the first layer comprises a polymeric resin selected from a group consisting of polyvinyl acetal, polyvinyl formal resins, epoxies, and combinations thereof.

13. The magnet wire of claim 1, further comprising an adhesive layer disposed around the coating, wherein the adhesive layer comprises a thermosetting adhesive resin.

14. The magnet wire of claim 1, wherein the filler has a surface treatment that includes the addition of surfactants, anti-settling agents, and antifoaming agents.

15. The magnet wire of claim 1, wherein the coating further comprises a slip-promoting agent selected from a group consisting of polyvinyl fluoride, tetrafluoroethylene (TFE) perfluoro (vinyl alkylic) copolymer, hexafluoropropylene-perfluoro (alkyl vinyl ether) copolymer, ethylene-tetrafluoroethylene copolymer, polytetrafluoroethylene, polyvinylidene fluoride, ethylene-chlorotrifluoroethylene copolymer, polychlorotrifluoroethylene, carnauba, montan wax, and combinations thereof.

16. The magnet wire of claim 1, wherein the coating comprises a coloring agent selected from a group consisting of titanium dioxide, chromium dioxide, and combinations thereof.

17. The magnet wire of claim 1, wherein the coating has a conductivity ranging from 1×10º S/cm to 1×10 S/cm.

18. A method for the generation and application of a composite coating and thereby producing a magnet wire, according to claim 1, the method comprising the steps of:
preparation of the nanoparticle and enamel mixture;
a. measure and weigh the required amount of nanoparticles and selected polymer precisely;
b. dissolve the polymer in the prepared solvent, ensuring a homogeneous mixture;
c. gradually incorporate the nanoparticles into the enamel while maintaining constant stirring with a high-speed disperser;
d. continue stirring for at least 1 hour to achieve uniform dispersion and prevent nanoparticle segregation;
addition of additives;
a. without interrupting the stirring, introduce the necessary additives to enhance nanoparticle dispersion in the enamel;
b. maintain stirring for an additional 2 hours to ensure proper dispersion and prevent nanoparticle sedimentation at the bottom of the container;
enameling process;
a. transfer the resulting mixture to an enameling machine designed to apply enamel to the wire;
wire coating;
a. pass the copper or aluminum wire at high speed through the enameling dies in the machine;
b. during this process, the wire is coated with thermally conductive enamel loaded with nanoparticles;
drying and curing;
a. the coated wire enters a drying and curing oven within the enameling machine;
b. in this oven, the solvent evaporates completely, and the polymer cures, achieving strong adhesion of the enamel to the wire;
obtaining the magnet wire with thermally conductive enamel;
a. once the solvent has completely evaporated and the curing process is completed, the magnet wire with thermally conductive enamel is ready for use; and
winding;
a. wind the finished magnet wire on appropriate spools, preparing it for various electromagnetic applications.

19. The method according to claim 18, wherein specific nanoparticles are selected from a group comprising hBN, BeO, or FeO, combinations thereof, and the like.

20. The method according to claim 18, wherein the amount of nanoparticles falls within a range of 0.5 to 15%.

21. The method according to claim 18, wherein the appropriate polymer is selected from a group comprising polyethylene (PE), polyetherimide (PEI), polyamideimide (PAI), or polyimide (PI), combinations thereof, and the like.

22. The method according to claim 18, wherein the polymer dissolution in the prepared solvent falls within a range of 18% to 45% solids.

23. The method according to claim 18, wherein additives are within a range of 0.1% to 2% of the total formulation.

24. The method according to claim 18, wherein a solvent mixture is prepared, the solvent mixture comprising any selected from a group comprising cresols, amines, and xylenols, combinations thereof, and the like, for effective polymer dissolution.

25. The method according to claim 18, wherein a container is used to hold the nanoparticle and enamel mixture.

26. The method according to claim 18, wherein a disperser is capable of stirring the mixture at a constant speed of approximately 1000 rpm.

27. The method according to claim 18, wherein an enameling machine is configured to apply the enamel to the magnet wire.

28. The method according to claim 18, wherein a drying and curing oven is configured to carry out the drying and curing process of the enamel once applied to the magnet wire, allowing for solvent removal and polymer solidification.

29. The method according to claim 18, wherein the drying and curing oven operates at a temperature ranging from 200° C. to 500° C.
